(19) United States
(12) Patent Application Publication
(10) Pub. No.: US 2008/0227076 A1
(43) Pub. Date: Sep. 18, 2008

(54) PROGRESS MONITOR AND METHOD OF DOING THE SAME

(76) Inventor: Byron Johnson, Chicago, IL (US)

Correspondence Address: HOLLAND & KNIGHT LLP, 10 ST. JAMES AVENUE, 11th Floor, BOSTON, MA, 02116-3889, US

(21) Appl. No.: 11/830,038

(22) Filed: Jul. 30, 2007

Related U.S. Application Data
(60) Provisional application No. 60/894,535, filed on Mar. 13, 2007.

(51) Int. Cl. G09B 5/00

(52) U.S. Cl. 434/310; 434/309

(57) ABSTRACT

A method, computer program product, and device for monitoring student progress may include providing a lesson selection menu for a user to select a lesson and providing a quantity selection menu for the user to select a quantity of lesson material to be rendered. The selected quantity of the selected lesson may be rendered on a computing device. A user input may be received indicating user progress toward completion of the rendered quantity of the selected lesson. Additionally, the user progress toward completion of the rendered quantity of the selected lesson may be communicated to at least one third party.

### CROSS-REFERENCE TO RELATED APPLICATIONS

This application claims the benefit of U.S. provisional patent application Ser. No. 60/894,535, filed Mar. 13, 2007, the entire disclosure of which is incorporated by reference.

### FIELD OF THE INVENTION

The present disclosure relates to learning tools, and more specifically to learning tools for monitoring student progress.

### BACKGROUND

Many tools and programs exist for helping students learn. Often, these tools and programs involve attending special learning sessions with tutors. In today's busy world in which both parents often work, there exists a need for such tools that are accessible from the home.

Additionally, different students require different types of help. For some students, reading from a lengthy text can be an intimidating task. There exists a need for learning tools that are configurable to the needs of individual students.

Further, it may be hard for parents and teachers alike to determine whether individual students are doing their school work and actually comprehending it and learning from it. There exists a need for a teaching tool that helps in monitoring the progress of individual students.

### SUMMARY

According to an implementation, a method for monitoring student progress may include providing a lesson selection menu for a user to select a lesson, and providing a quantity selection menu for the user to select a quantity of lesson material to be rendered. The method may also include rendering the selected quantity of the selected lesson on a computing device. A user input may be received indicating user progress toward completion of the rendered quantity of the selected lesson, and the user progress toward completion of the rendered quantity of the selected lesson may be communicated to at least one third party.

One or more of the following features may be included. The selected lesson may be rendered in one of an audio or a text based format. Furthermore, the quantity of lesson material to be rendered may be selected from the group consisting of chapters, pages, paragraphs, and lines of text. Additionally, the lesson selection menu may include a user-specific list of lessons.

Additional quantities of the selected lesson may be rendered in response to the input indicating user progress toward the completion of the rendered quantity of the selected lesson. A user comprehension test based upon, at least in part, the rendered quantity of the selected lesson may be rendered. An indicator of user progress toward completion of the selected lesson may be provided.

Communicating progress information to a third party may include uploading user progress information. User progress information may be based at least in part on the received user input indicating user progress toward completion of the rendered quantity of the selected lesson, and may be based upon, at least in part, a result of the user comprehension test. A user progress report based upon, at least in part, the user progress information may be generated, and the user progress report may be communicated to the at least one third party.

According to another implementation, a computer program product residing on a computer readable medium having a plurality of instructions stored thereon which, when executed by a processor, cause the processor to perform operations including providing a lesson selection menu for a user to select a lesson, and providing a quantity selection menu for the user to select a quantity of lesson material to be rendered. The computer program product may also include instructions for rendering the selected quantity of the selected lesson on a computing device. Furthermore, the computer program product may include instructions for receiving a user input indicating user progress toward completion of the rendered quantity of the selected lesson, and communicating the user progress toward completing of the rendered quantity of the selected lesson to at least one third party.

One or more of the following features may also be included. The selected lesson may be rendered in one of an audio or a text based format. Additionally, the quantity of lesson material to be rendered is selected from the group consisting of chapters, pages, paragraphs, and lines of text. The lesson selection menu includes a user-specific list of lessons. The computer program product may also include instructions for rendering additional quantities the selected lesson in response to the user input indicating user progress toward completion of the rendered quantity of the selected lesson. Furthermore, the computer program product may also include instructions for rendering a user comprehension test based upon, at least in part, the rendered quantity of the selected lesson.

The instructions for communicating progress information to a third party may include instructions for uploading user progress information. The user progress information may be based, at least in part, upon on the received user input indicating user progress toward completion of the rendered quantity of the selected lesson. The user progress information may also be based upon, at least in part, a result of the user comprehension test. The computer program product may also include instructions for generating a user progress report based upon, at least in part, the user progress information, and for communicating the user progress report to the at least one third party.

According to yet another implementation, a student progress monitor may include a computing device configured to perform operations including providing a lesson selection menu for a user to select a lesson and providing a quantity selection menu for the user to select a quantity of lesson material to be rendered. The computing device of the student progress monitor may also include instructions for rendering the selected quantity of the selected lesson on the computing device. The computing device may be configured for receiving a user input indicating user progress toward completion of the rendered quantity of the selected lesson, and communicating user progress information toward completion of the rendered quantity of the selected lesson to at least one third party.

One or more of the following features may also be included. The computing device may be selected from the group consisting of: a client computer, a notebook computer, a laptop computer, and a personal digital assistant. The quantity of lesson material to be rendered is selected from the group consisting of chapters, pages, paragraphs, and lines of text. The computing device may be further configured to perform operations including rendering additional quantities the selected lesson in response to the user input indicating user progress toward completion of the rendered quantity of the selected lesson. The computing device may additionally be configured to perform operations including rendering a user comprehension test based upon, at least in part, the rendered quantity of the selected lesson.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a student progress monitoring process coupled to a distributed computing network

FIG. 2 is a flowchart of a process executed by the student progress monitoring process of FIG. 1.

FIG. 3 is a screen shot of a user interface screen.

FIG. 4 is a screen shot of a window displaying a first selected quantity of a selected lesson.

FIG. 5 is a screen shot of a window displaying a second quantity of the selected lesson and a comprehension test.

### DETAILED DESCRIPTION

### System Overview:

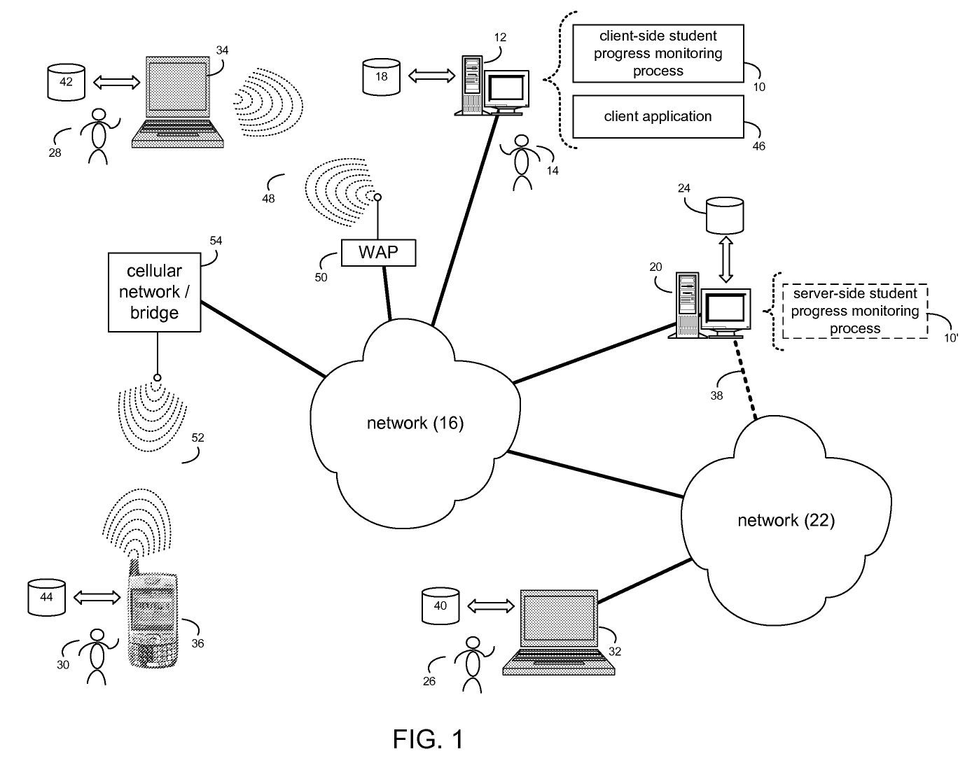

Referring to FIG. 1, there is shown a student progress monitoring process 10 that may monitor and/or track the progress of a student in consuming lesson material, or a portion of the lesson material. Student progress monitoring process 10 may reside on and may be executed by a computing device (e.g., client computer 12). As will be discussed below in greater detail, student progress monitoring process 10 may enable a student (e.g., user 14) to select lessons for consuming in discreet quantities until the lesson is completed, e.g., until the student has consumed the entirety of the selected lesson material, or a selected portion thereof. Student progress monitoring process 10 may track the user's progress, and may report the tracked progress to a third party.

Student progress monitoring process 10 may be a client-side application that resides on and is executed by a computing device, e.g., client computer 12, which may be connected to network 16 (e.g., the Internet). The instruction sets and subroutines of student progress monitoring process 10, which may be stored on a storage device 18 coupled to client computer 12, may be executed by one or more processors (not shown) and one or more memory architectures (not shown) incorporated into client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, student progress monitoring process 10′ may be a server-based application, as represented in FIG. 1 by server-side student progress monitoring process 10′ (shown in phantom). Server-side student progress monitoring process 10′ may reside on and be executed by server computer 20, which may be coupled to network 16. Examples of server computer 20 may include, but are not limited to: a single server computer, a series of server computers, a mini computer, and a mainframe computer, for example. Server computer 20 may execute a network operating system, examples of which may include but are not limited to: Microsoft Windows XP Server™; Novell Netware™; or Redhat Linux™, for example.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 16. Network 16, and/or server computer 20, may be coupled to one or more secondary networks (e.g., network 22), examples of which may include but are not limited to: a local area network; a wide area network; or an intranet, for example.

The instruction sets and subroutines of server-side student progress monitoring process 10′, which may be stored on a storage device 24 coupled to data server 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the student progress monitoring process may be a client-side application (e.g., client-side student progress monitoring process 10), a server-side application (e.g., server-side student progress monitoring process 10′), or a hybrid client-side/server-side application (e.g., using portions of both client-side student progress monitoring process 10 and server-side student progress monitoring process 10′). Accordingly, the manner in which the student progress monitoring process is accessed may vary depending on whether the student progress monitoring process is a client-side application, a server-side application, or a hybrid client-side/server-side application.

If a client-side application, one or more users (e.g., users 14, 26, 28, 30) may access the client-side student progress monitoring process 10 directly through the computing device on which the client-side student progress monitoring process 10 is executed. Computing devices may include, but are not limited to, client computer 12, notebook computer 32, laptop computer 34, and personal digital assistant 36, for example. As described above, the instruction sets and subroutines of client-side student progress monitoring process 10, which may be stored on a storage device (e.g., storage devices 18, 40, 42, 44) coupled to the computing device (e.g., client computer 12, notebook computer 32, laptop computer 34, and personal digital assistant 36, respectively), may be executed by one or more processors (not shown) and one or more memory architectures (not shown) incorporated into the computing device. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Alternatively, server-side student progress monitoring process 10′ may be accessed by users 14, 26, 28, 30 through network 16 or through secondary network 22. Server computer 20 (i.e., the computer that executes server-side student progress monitoring process 10′) may be coupled to network 16 through secondary network 22, as illustrated with phantom link line 38.

Computing device, e.g., client computer 12, notebook computer 32, laptop computer 34 and personal digital assistant 36, may execute a client application (e.g., client application 46) to access server-side student progress monitoring process 10′. Client application (e.g., client application 46) may interface with server-side student progress monitoring process 10′ and facilitate the bidirectional transfer of data between e.g., client computer 12 and server computer 20. In such an implementation, client-side student monitoring process 10 may be a stand-along application, or may be a plug-in or applet, that may be executed and/or accessed in the environment of client application 46.

The client application (e.g., client application 46) may be, for example, a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34, and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34, and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows, e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### The Student Progress Monitoring Process:

As discussed above, the student progress monitoring process 10, 10′ may be a client-side application, a server-side application, or a hybrid client-side/server-side application. Accordingly, the following disclosure is applicable to all variants of the student progress monitoring process.

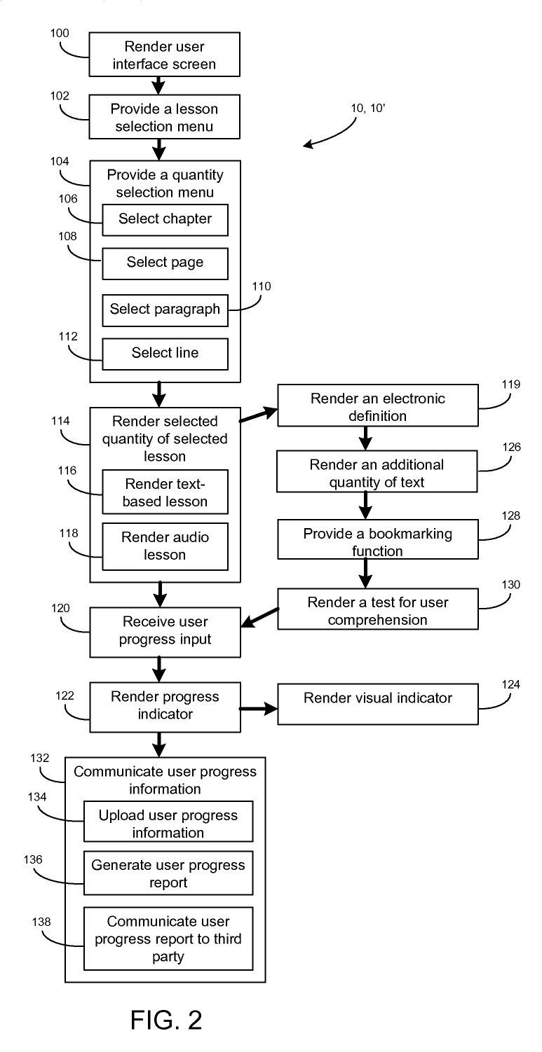

Referring also to FIG. 2, student progress monitoring process 10 may render 100 user interface screen, which may enable a user (e.g., user 14 of client computer 12) to perform various tasks associated with completing a selected lesson. The manner in which user interface screen is presented to user 14 may vary depending on whether the student progress monitoring process is a client-side application, a server-side application, or a hybrid client-side/server-side application.

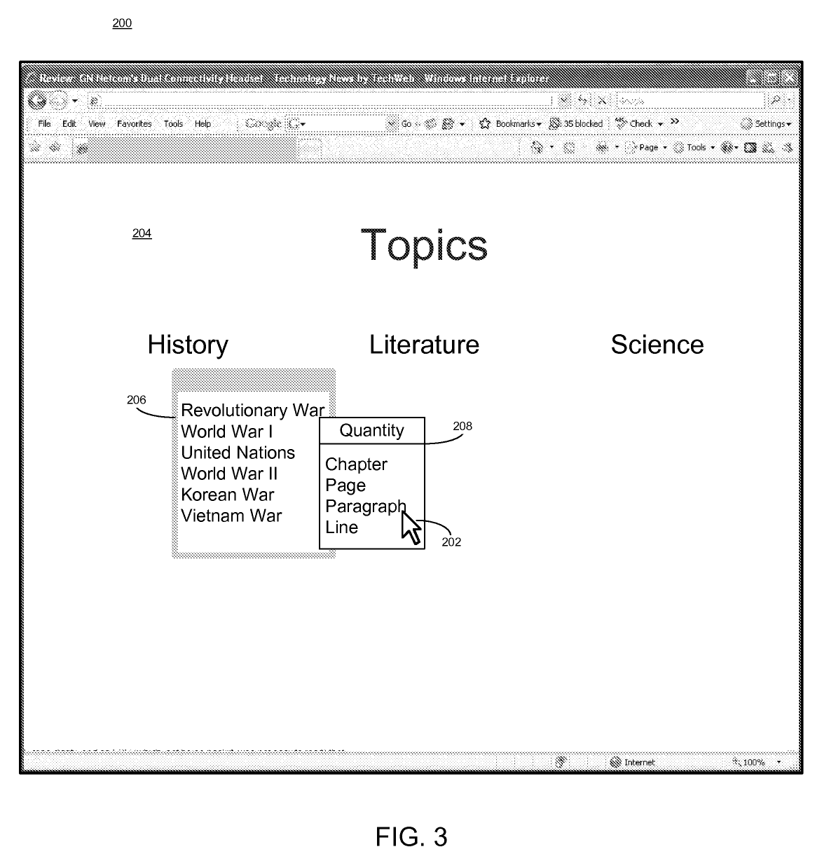

Referring also to FIG. 3, user interface screen 200 may enable user 14 to select, e.g., using a screen pointer 202, controlled by pointing device, such as a mouse (not shown), a lesson from a lesson selection menu 204 that may be provided 102. The lesson selection menu 204 may include a list or sub-topic drop down menu 206 of specific lessons or sub-topics. For example, the lesson selection menu 204 may include history, literature and science lesson topics. Using screen pointer 202 user 14 may select the general lesson topic history. Selection of the history general lesson topic may activate sub-topic drop down menu 206, that may present specific history related lesson topics, such as the American Revolutionary War, World War I, the Formation of the United Nations, World War II, Korean War, or Vietnam War.

The listing of multiple lesson topics and sub-topics may, for example, enable a teacher or tutor who wishes to determine the reading level of user 14, or diagnose a learning disability of user 14 may instruct that student to log in and select any topic for reading. Alternatively, lesson selection menu 204 may include user-specific lessons that have been chosen as a curriculum or lesson plan for an individual user or class. For example, a teacher may require that her students use student progress monitoring process. When each student logs in, the lesson selection menu may include lessons that the teacher chose for the student individually, or for her class as a whole. In this way, the lesson selection menu may be custom-tailored to individual students or for whole classes.

Continuing with the above-stated example, user 14 may have selected (using screen pointer 202) the general topic “history” and the sub-topic “Revolutionary War.” Student progress monitoring process 10 may provide 104 a quantity selection menu (e.g., in the form of quantity selection drop down menu 208) from which the user 14 may select a quantity of lesson material to be rendered. The quantity selection menu may be quantity selection drop down menu 208, or may be, for example, a list, a series of buttons or similar selection feature. As shown, quantity selection drop down menu may enable user 14 to select a quantity of the selected lesson to be rendered, e.g., in chapters 106, pages 108, paragraphs 110, or lines 112 of text. User 14 may select the desired quantity of text to be rendered, e.g., from quantity selection drop down menu 208. For example, user 14 may select the quantity size “paragraph” using screen pointer 202. Quantity selection drop down menu 208 may enable user 14 to choose the amount of the selected lesson to be presented at one time. This may be helpful in that some students may be intimidated by large quantities of text. By presenting a reading assignment in small increments, the reading task may feel less daunting and more accomplishable for such students.

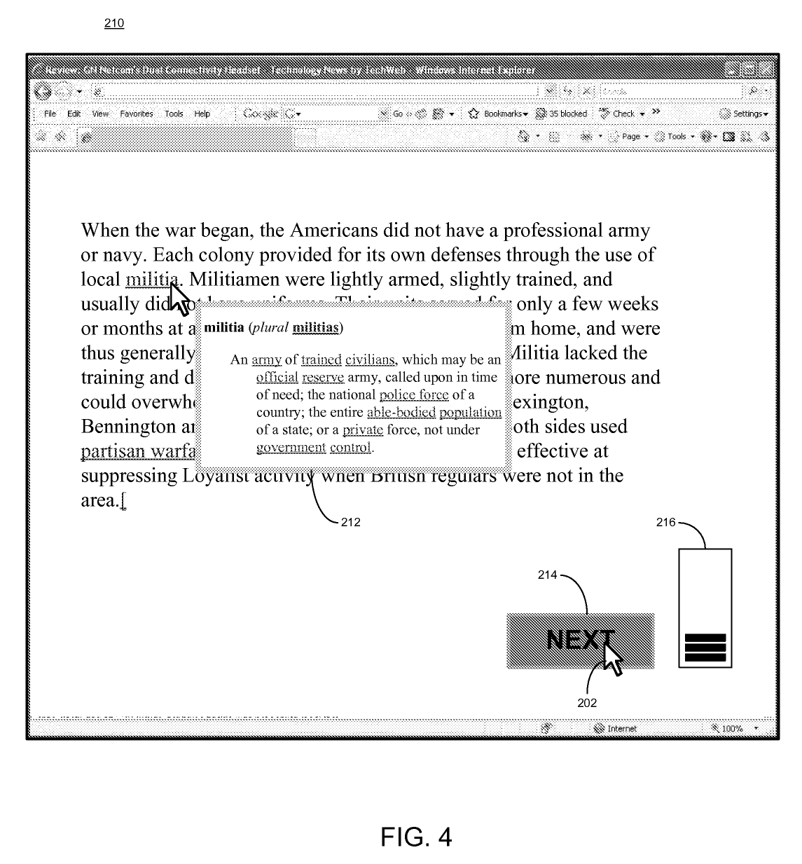

Student progress monitoring process 10 may render 114 the selected quantity of the selected lesson in a variety of formats. For example, student progress monitoring process 10 may render 114 the selected quantity in text format 116. Alternatively, the selected lesson may be rendered 114 on the computing device in an audio format 118, enabling a user to listen to the selected lesson. If the lesson is rendered 114 in an audio format 118, student progress monitoring process 10 may also render 116 text of the selected lesson, e.g., enabling user 14 to read along with the rendered 118 audio output. Continuing with the above-stated example, and with reference to FIG. 4, student progress monitoring process 10 may render 114 one paragraph of text 116 relating to the American Revolutionary war in window 210 on a display of a computing device 12.

Student progress monitoring process 10 may provide assistance modules to facilitate comprehension of the rendered 114 lesson. For example, student progress monitoring process 10 may render 119 an electronic definition of a selected word. For example, if a user 14 is struggling with a word while reading (e.g., because he does not know the word or understand how it is being used) the user 14 may select the word for defining. For example, as shown in FIG. 4, the word “militia,” may be selected e.g., using screen pointer 202, and a definition may be rendered 119 for that word, e.g., in a dialog box 212 in window 210. User 14 may select the word by clicking, double clicking or highlighting the word, for example.

User 14 may indicate progress in consuming the rendered 114 quantity of the lesson. For example, as user 14 reads the rendered 114 quantity of the selected lesson, user may indicate progress within the lesson, e.g., by clicking “NEXT” button 214 at the bottom of window 210. Additionally/alternatively, user 14 may indicate progress in consuming the rendered quantity of the lesson by moving a cursor through completed words, clicking on the end of a completed sentence or highlighting completed text. Input indicative of user progress may be stored locally on the computing device, e.g., in the case of a client-side student progress monitoring process 10, or it may be stored on a server, in the case of a server-side student progress monitoring process 10′. User input indicating user progress toward completion of the selected quantity of the selected lesson may be received 120 by student progress monitoring process 10.

A progress indicator configured to track user progress information may be rendered 122, e.g., in window 210. The user input indicating progress may be used to track the user 14's progress by enabling an analysis of words or lines per minute. The progress indicator may track user progress information by rendering 124 a visual indicator reflecting the user progress input. For example, progress indicator may be rendered as bar graph 216, or in the form of underlining, bolding, highlighting, or color-changing text that has been read by the user.

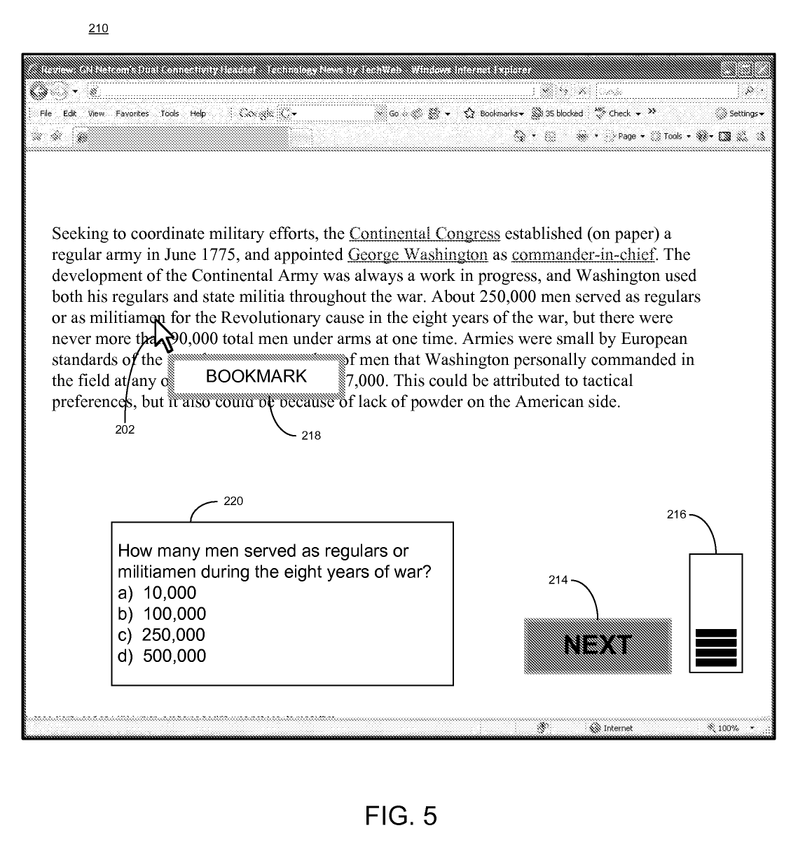

When user 14 has indicated that the rendered 114 portion of the lesson has been completed, e.g., by clicking button 214, student progress monitoring process 10 may render 126 additional quantities of the selected lesson. Student progress monitoring process 10 may render 126 additional quantities of text or audio whenever user 14 indicates completion of the rendered material. As shown in FIG. 5, the additional quantities of text (or audio) may be rendered in window 210 as described above. If the goal for user 14 is to complete an entire lesson or a portion of a lesson, an additional selected quantity may be rendered 126 automatically or upon user input requesting the additional quantity, e.g., clicking button 214. The additional quantities may be rendered 126 in the same quantity, e.g., chapters, pages, paragraphs, and lines of text, as selected by the user upon commencing the lesson. Additional quantities may be rendered 126 until the user has completed the lesson or portion of lesson.

Student progress monitoring process 10 may provide 128 a bookmarking function, for example, if user 14 is unable to finish the lesson all at once. User 14 may initiate bookmark option button 218, e.g., by right clicking on the last portion of text read. Bookmark option button 218 may provide the option to bookmark the rendered 114 portion of the lesson. In this way, user 14 may return to the bookmarked portion of the lesson at a later time. In the case of a server-side student progress monitoring process or a hybrid client-side/server-side student progress monitoring process, user 14 may access the bookmarked lesson from different computing devices. The bookmark, i.e., location in the selected lesson, may be stored on the server-side, enabling access to the bookmarked point from any enabled computing device.

Student progress monitoring process 10 may render 130 a comprehension test, e.g., to determine user 14 comprehension or to verify that user 14 has consumed the rendered 114 portion of the lesson. That is, the test may be configured to determine whether the student has actually read the selected lesson and whether the student understood what he read. For example, and continuing with the above-stated example, the rendered 130 test may include one or more questions directed at the subject of the rendered 114 portion of the lesson. As shown in FIG. 5, test dialog box 220 may include one or more multiple choice questions 214 at the bottom of the text. User 14 may select a desired answer, e.g., using screen pointer 202. Alternatively/additionally, the test may be rendered 130 on a separate screen or in a separate window (not shown) to evaluate comprehension and retention, e.g., without permitting direct reference to the rendered quantity of the lesson.

Student progress monitoring process 10 may communicate 132 progress information to one or more third parties, e.g., one or more of users 26, 28, 30. Progress information may be communicated, e.g., on an on-going basis, periodically, or upon completion of the selected lesson. Student progress monitoring process 10 may communicate 132 progress information via one or more of networks 16 or 22. User 14 may choose to send the progress information, e.g., upon completing the lesson, or the information may be sent automatically. The third party may be a parent, a teacher or tutor, or a learning specialist working with the student user. The third party or parties may be designated by the student upon sending the information or they may be pre-selected and programmed in for automatic notification.

Progress information may be communicated to the third party using, for example, a dedicated program (e.g., student progress monitoring process 10, or a module thereof), via email, voicemail, instant messaging, text messaging, and the like. For example, student progress monitoring process 10 may send an email through one or more of networks 16, 22 notifying user 28 of user 14's progress and/or results of comprehension test.

To communicate 132 progress information to a third party, student progress monitoring process 10 may, for example, upload 134 user progress information, which may include the amount of the selected lesson consumed by user 14 and user comprehension test results, e.g., after user 14 has completed the selected lesson. The user progress information and user comprehension test results may be stored on a computing device, e.g., in the case of a client-side student progress monitoring process 10, progress information, results of comprehension test, and the like, may be stored on client computer 12. Additionally/alternatively, progress information, results of comprehension test, and the like, may be uploaded to server computer 20, in the case of server-side student progress monitoring process 10′ or a hybrid client-side/server-side student progress monitoring process. The stored or uploaded user progress information and user comprehension test results may be emailed to one or more selected or pre-determined third parties. Additionally/alternatively, rather than sending the user progress information and/or user comprehension test results, a notification that the results have been uploaded be sent to one or more third parties. The uploaded information (i.e., user progress, comprehension test results, and the like) may be available for viewing or downloading by one or more third parties (e.g., users 26, 28, 30).

Rather than communicating raw data (e.g., progress and/or raw comprehension test results) to the one or more third parties, student progress monitoring process 10 may generate 136 a user progress report based upon the user progress information and user comprehension test results. The report may be, for example, configured to track progress over time from lesson to lesson, display the current lesson data, identify user comprehension test questions answered correctly/incorrectly. User progress report may include various other information that may be useful for tracking user 14's progress and/or comprehension. Student progress monitoring process 10 may communicate 138 the user progress report to one or more third parties, as described above.

A number of implementations have been described. Nevertheless, it will be understood that various modifications may be made. Accordingly, other implementations are within the scope of the following claims.

What is claimed is:

1. A method for monitoring student progress comprising:
providing a lesson selection menu for a user to select a lesson;
providing a quantity selection menu for the user to select a quantity of lesson material to be rendered;
rendering the selected quantity of the selected lesson on a computing device;
receiving a user input indicating user progress toward completion of the rendered quantity of the selected lesson;
communicating the user progress toward completion of the rendered quantity of the selected lesson to at least one third party.

2. The method of claim 1, wherein the quantity of lesson material to be rendered is selected from the group consisting of chapters, pages, paragraphs, and lines of text.

3. The method of claim 1, wherein the lesson selection menu includes a user-specific list of lessons.

4. The method of claim 1, wherein the selected lesson is rendered in one of an audio or a text based format.

5. The method of claim 1 further comprising rendering additional quantities of the selected lesson in response to the input indicating user progress toward the completion of the rendered quantity of the selected lesson.

6. The method of claim 1, further comprising rendering a user comprehension test based upon, at least in part, the rendered quantity of the selected lesson.

7. The method of claim 1, further comprising providing an indicator of user progress toward completion of the selected lesson.

8. The method of claim 6, wherein communicating progress information to a third party comprises:
uploading user progress information, based at least in part on the received user input indicating user progress toward completion of the rendered quantity of the selected lesson, and based upon, at least in part, a result of the user comprehension test;
generating a user progress report based upon, at least in part, the user progress information; and
communicating the user progress report to the at least one third party.

9. A computer program product residing on a computer readable medium having a plurality of instructions stored thereon which, when executed by a processor, cause the processor to perform operations comprising:
providing a lesson selection menu for a user to select a lesson;
providing a quantity selection menu for the user to select a quantity of lesson material to be rendered;
rendering the selected quantity of the selected lesson on a computing device;
receiving a user input indicating user progress toward completion of the rendered quantity of the selected lesson;
communicating the user progress toward completing of the rendered quantity of the selected lesson to at least one third party.

10. The computer program product of claim 9, wherein the quantity of lesson material to be rendered is selected from the group consisting of chapters, pages, paragraphs, and lines of text.

11. The computer program product of claim 9, wherein the lesson selection menu includes a user-specific list of lessons.

12. The computer program product of claim 9, wherein the selected lesson is rendered in one of an audio or a text based format.

13. The computer program product of claim 9, further comprising instructions for rendering additional quantities the selected lesson in response to the user input indicating user progress toward completion of the rendered quantity of the selected lesson.

14. The computer program product of claim 9, further comprising instructions for rendering a user comprehension test based upon, at least in part, the rendered quantity of the selected lesson.

15. The computer program product of claim 14, wherein the instructions for communicating progress information to a third party comprise instructions for:
uploading user progress information, based at least in part on the received user input indicating user progress toward completion of the rendered quantity of the selected lesson, and based upon, at least in part, a result of the user comprehension test;
generating a user progress report based upon, at least in part, the user progress information; and
communicating the user progress report to the at least one third party.

16. A student progress monitor comprising:
a computing device configured to perform operations including:
providing a lesson selection menu for a user to select a lesson;
providing a quantity selection menu for the user to select a quantity of lesson material to be rendered;
rendering the selected quantity of the selected lesson on the computing device;
receiving a user input indicating user progress toward completion of the rendered quantity of the selected lesson;
communicating user progress information toward completion of the rendered quantity of the selected lesson to at least one third party.

17. The student progress monitor of claim 16, wherein the computing device is selected from the group consisting of: a client computer, a notebook computer, a laptop computer, and a personal digital assistant.

18. The student progress monitor of claim 16, wherein the quantity of lesson material to be rendered is selected from the group consisting of chapters, pages, paragraphs, and lines of text.

19. The student progress monitor of claim 16, the computing device further configured to perform operations including rendering additional quantities the selected lesson in response to the user input indicating user progress toward completion of the rendered quantity of the selected lesson.

20. The student progress monitor of claim 16, the computing device further configured to perform operations including rendering a user comprehension test based upon, at least in part, the rendered quantity of the selected lesson.
